(19) United States
(12) Patent Application Publication
(10) Pub. No.: US 2016/0259890 A1
(43) Pub. Date: Sep. 8, 2016

(54) Method for development of a clinical database, and application of statistical probability estimation methods for design and analysis of clinical studies and assesment of treatment metrics

(71) Applicant: Nikhil Singhvi, Basking Ridge, NJ (US)

(72) Inventor: Nikhil Singhvi, Basking Ridge, NJ (US)

(73) Assignee: CURAMATIX CLINICAL SOLUTIONS, Basking Ridge, NJ (US)

(21) Appl. No.: 14/637,276

(22) Filed: Mar. 3, 2015

(51) Int. Cl. G06F 19/00; G06F 17/30

(52) U.S. Cl. CPC G06F 19/322; G06F 17/30339; G06F 19/363; G06F 19/3431

(57) ABSTRACT

A method for developing a database using data from multiple sources is proposed, which can be used to generate a cohort of valid sample population to serve as a clinical database to support statistical probability analysis and evaluation of treatment metrics. This clinical database can provide the relationships between parameters and attributes that can be used to compute statistical indices to support clinical study design and analysis. The statistical modeling can reduce the number of patients to be enrolled, while the statistical analysis can be used to test analysis methods. to project outcomes, and to confirm the external validity of completed studies. This clinical database can also support the determination of treatment comparator and therapeutic treatment metrics.

### CROSS-REFERENCE TO RELATED APPLICATIONS

U.S. Pat. No. 5,508,912; Clinical database of classified out-patients for tracking primary care outcome; Schneiderman

U.S. Pat. No. 7,788,202; System and method for deriving a hierarchical event based database optimized for clinical applications; Friedlander, et al.

U.S. Pat. No. 8,068,993; Diagnosing inapparent diseases from common clinical tests using Bayesian analysis; Karlov, et al.

U.S. Pat. No. 8,131,769; Processing drug data; Gogolak, et al.

U.S. Pat. No. 8,150,713; Pharmaceutical treatment effectiveness analysis computer system and methods; Clements, et al.

U.S. Pat. No. 8,175,896; Computer systems and methods for selecting subjects for clinical; Dalton, et al.

U.S. Pat. No. 8,200,509; Masked data record access; Kenedy, et al.

U.S. Pat. No. 8,234,294; Method and system of unifying data; Shlaes, et al.

U.S. Pat. No. 8,364,500; Publisher gateway systems for collaborative data exchange, collection, monitoring and/or alerting; Eisenberger, et al.

U.S. Pat. No. 8,386,278; Methods, systems, and devices for managing transfer of medical; Maresh et al

### STATEMENT REGARDING FEDERALLY SPONSORED RESEARCH OR DEVELOPMENT

Not Applicable

### BACKGROUND OF THE INVENTION

This invention relates to development of a clinical database and, more particularly, the computation of predictive statistics in support of clinical study design, analysis of the clinical study data, and treatment metrics. In the consideration of clinical study design for determination of therapeutic benefits, adverse events, safety metrics, and other outcomes, statistical tools are employed to generate an estimation of the number of patient population that is required in the treatment arms. Currently, the statistical considerations for a clinical study design include limited data available from prior studies to plan pivotal studies to deliver a statistically valid result. In most cases, the availability of data is limited to Phase II clinical studies or historical data that are available to the organization at the time of clinical study design. The constraint in this amount of information available limits the confidence in the metrics leading to larger potential sample size required for the clinical study. It is therefore apparent that there is a need for a clinical database that could provide more historical information for clinical study design and then for validation of study results upon study completion.

### BRIEF SUMMARY OF THE INVENTION

A method for developing a database using data from multiple sources is proposed, which can be used to generate a cohort of valid sample population to serve as a clinical database to support statistical probability analysis and evaluation of treatment metrics. This clinical database can provide the relationships between parameters and attributes that can be used to compute statistical indices to support clinical study design and analysis. The statistical modeling can reduce the number of patients to be enrolled, while the statistical analysis can be used to test analysis methods, to project outcomes, and to confirm the external validity of completed studies. This clinical database can also support the determination of treatment comparator and therapeutic treatment metrics.

With this invention, we disclose a system for developing a clinical database, which will provide priori information based on the clinical experience in real world setting using a multitude of health care data sources that can in turn be used to support the statistical requirements in a subsequent clinical study.

A system can be developed to extract unidentified patient information that is compliant with prevailing privacy requirements from multiple healthcare data sources. The extracted information can be compiled into a clinical database that includes patient demographics and associated disease characteristics, diagnosis, treatment, and outcome events. The priori information available in the clinical database can augment and improve precision in the development and conduct of the clinical study design and calculation of sample size. The information in the clinical database can also be readily mined and analyzed for various types of epidemiological, clinical, safety, and other studies.

### DETAILED DESCRIPTION OF THE INVENTION

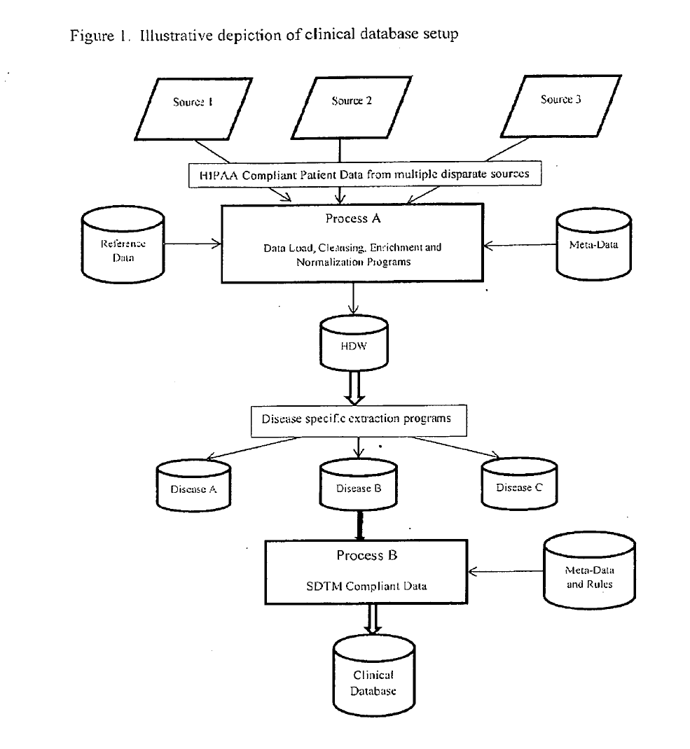

An illustrative process for development of the clinical database is described herewith. As depicted in FIG. 1, multiple heterogeneous unidentified patient healthcare datasets are collected from Source 1, Source 2, Source 3, et cetera. The data sources include the data from payers and providers. The attributes related to diagnosis, treatment, outcome et cetera are identified and selected.

Process A: Data quality checks are performed to validate the data accuracy and completeness. A healthcare specific reference data is setup. Metadata is setup to define the file formats from various data sources and the rules for enrichment and loading. This data is then correlated based on the demographic and geographical attributes and normalized to build a healthcare data warehouse (HDW). The data in the repository is recorded in a longitudinal time-series basis to depict relationship of unidentified patients to the healthcare treatments and outcomes. This data is periodically enriched with accruing data to keep it current. Algorithms are then applied to this data repository to create extracts that represent the unidentified patient data pertaining to a specific medical condition, such as Disease A, Disease B Disease C, et cetera. These extracts are then used to create subsets of data that are available for fast queries, views and reports across multiple attributes.

Process B: Rules and meta-data are defined to interpret the data format, data inclusion criterion, data-conversion and mapping logic. A set of programs are created that reads the disease specific extracts and use the defined rules and meta-data to generate standard data tabulation module (SDTM) compliant clinical database, which can provide demographics and disease characteristics parameter and outcome associated with patient based on the treatment received. The demographic parameters, for example, could include patient's age, gender, race, ethnicity, geographic location, et cetera, and disease characteristics would include the type and extent of the disease, pre-existing co-morbid conditions, number and type of prior treatment received for disease under investigation, pathological and/or molecular sub-type/ genetic variations of the disease under investigation etc. The outcomes data point could measure effectiveness or adverse events rates, for example, patient survival, progression or response, or adverse event/side effects for which the patient was admitted to the hospital or received treatment/transfusion etc. These parameters would describe the probability of survival, treatment effectiveness, adverse event rate, and demographics or disease characteristics prognosis and/or prediction.

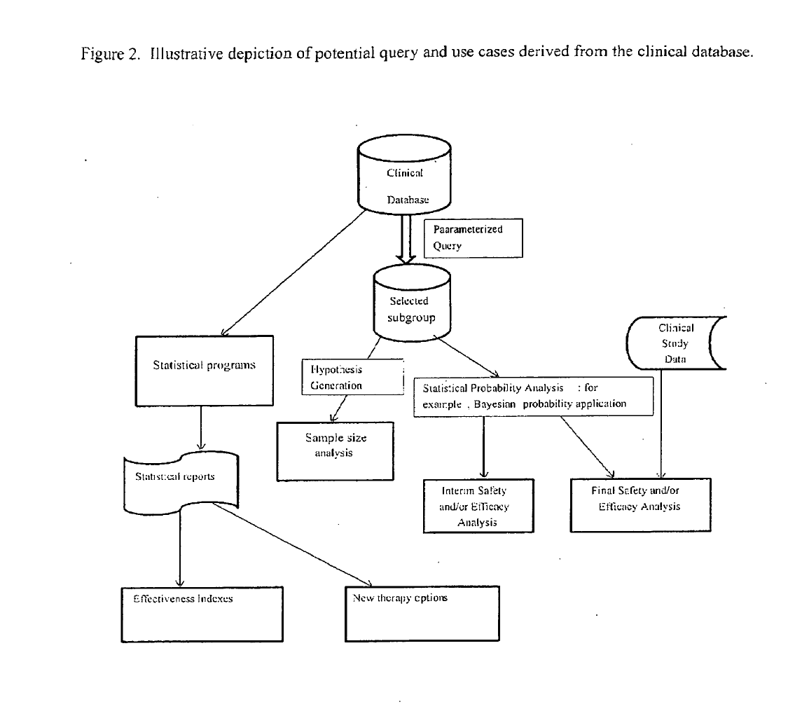

The clinical database information is intended to support various statistical calculations and analysis. An illustration of the various processes that can be supported by the clinical database is depicted in FIG. 2. The clinical database serves as the platform for assessment of therapeutic profiles, clinical study development, design, and sample size determination.

In one aspect of the invention, this clinical database can provide unidentified patient data to serve as historical and/or concurrent control in part or full for the clinical trials being conducted specially with an active comparator arm. Consider the assessment of the sample size for a clinical trial, wherein one has to make assumptions based on existing therapy for a particular disease under consideration. The clinical database can be used with both Frequentist and Bayesian approaches to supply background information to develop the number of patients required for a clinical study. While the clinical trial is underway, the clinical database can be used to assess the results of interim analysis based on a priori information and probability of success of the trial upon completion. In combination with adaptive design, the availability of this analytical information has the potential to permit a reduction in patient enrollment required in a clinical study, or stop the study early in situation where the probability of success is low.

A more granular illustration of the steps involved is presented in the following examples:

### Example 1

At the time of designing a breast cancer study with a new drug (Drug B) as an add-on therapy to Drug A to test a combination of Drug A and Drug B, a sample size calculation is needed. Data are available for patients who had received Drug A. A clinically meaningful advantage relative to Drug A is hypothesized. This projection is used to create a study hypothesis as follows—

Hₐ=Average Efficacy parameter when patient is treated with Drug A+Drug B is better by an estimate of 6 months as compared to patient treated with Drug A alone
H₀=Efficacy parameter when patient is treated with Drug A+Drug B is not better as compared to patient treated with Drug A alone

The historical control outcome for Drug A assessed from the clinical database is then plugged into the sample size calculation software like nQuery or SAS et cetera, which computes the sample size required for clinical study enrollment. Traditionally, the estimated efficacy for Drug A is derived from published clinical study results or previous study data for Drug A+Drug B held by the involved parties. The large group of patient information available in the clinical database provides more robust estimate of Drug A which will provide substantial benefits by more reliably determining the sample size required for clinical study relative to the traditional computation of the sample size from a set of limited patient data pool.

Once the study starts, the patient data from the clinical database can also be utilized for confirming control group outcome in the study design and double checking any decision for stopping trials early.

### Example 2

An approved drug, device, or biologic can be analyzed to support post market approvals and subsequent extended labeling claims. The application impacts long term efficacy surveillance as well as safety monitoring.

Suppose a therapy is approved to reduce total cholesterol among patients. The long term efficacy and safety beyond 6 months may not have not been studied but lipid and liver function data are available from patients treated with this therapy. Such data can be collected and analyzed to test if the efficacy and safety are sustained beyond the first 6 months. Shewhart cusum algorithms can be applied to test for subsequent patient-specific elevations in total cholesterol or for accompanying liver function tests such as AST while longitudinal models can be applied to aggregated croups of patients to test for rising trends over time for the same parameters.

Such analyses can be used to extend labelling claims which increase the valuation of the approved therapy or can be used to identify emergent safety concerns.

This derived information adds value to the therapy being considered for extended use.

### Example 3

The extension of efficacy and safety claims can also be extrapolated to populations not included in labeling claims. For example, a treatment that is approved to treat elevated blood pressure (diastolic blood pressure>85 mm Hg) is to be considered for treating patients with marginally elevated blood pressure (diastolic blood pressure>80 mm Hg) following the release of new guidelines that define elevated blood pressure to be>80 mm Hg. Efficacy and safety data from a series of patients with diastolic blood pressure>85 mm Hg can be examined to create a statistical model to predict the amount of blood pressure reduction. If 95% of all patients experience a 5-7% reduction in diastolic blood pressure independent of the starting diastolic blood pressure, then it can be hypothesized that patients with diastolic blood pressure between 80 and 85 mm Hg can similarly benefit without the need for the same formal clinical testing that led to the approval to treat patients with diastolic blood pressure>85 mm Hg. This can save Sponsors and regulatory agencies time and money to reach those in need of blood pressure medication.

These examples illustrate the added aspects of the invention to select a treatment and to employ statistical tools to the clinical database using the outcomes data of the patient population existing within the system to develop the effectiveness indices of that treatment such as patient compliance, cost benefit, medical services need, et cetera.

Afore examples in the Detailed Description sections are provided for illustrative purpose and there are alterations, modifications, permutations, and substitute equivalents, which fall within the scope of this invention. it should also be noted that there are many alternative ways of implementing the methods and applications of the present invention and the illustrations are not intended to limit the scope of the present invention. It is therefore intended that the following appended claims be interpreted as including all such alterations, modifications, permutations, and substitute equivalents to fall within the true spirit and scope of the present invention.

### Description of FIG. 1

FIG. 1 represents various steps involved in building a Clinical database. Multiple heterogeneous unidentified patient healthcare datasets are collected from Source 1, Source 2, Source 3, et cetera. The data sources include the data from payers and providers. The attributes related to diagnosis, treatment, outcome et cetera are identified and selected.

Within Process A, data quality checks are performed to validate the data accuracy and completeness. A healthcare specific reference data is setup. Metadata is setup to define the file formats from various data sources and the rules for enrichment and loading. This data is then correlated based on the demographic and geographical attributes and normalized to build a healthcare data warehouse (HDW). The data in the repository is recorded in a longitudinal time-series basis to depict relationship of unidentified patients to the healthcare treatments and outcomes. This data is periodically enriched with accruing data to keep it current. Algorithms are then applied to this data repository to create extracts that represent the unidentified patient data pertaining to a specific medical condition, such as Disease A, Disease B, Disease C, et cetera. These extracts are then used to create subsets of data that are available for fast queries, views and reports across multiple attributes.

Rules and meta-data are defined to interpret the data format, data inclusion criterion, data-conversion and mapping logic. Process B refers to a set of programs that reads the disease specific extracts and use the defined rules and meta-data to generate standard data tabulation module (SDTM) compliant clinical database, which can provide demographics and disease characteristics parameter and outcome associated with patient based on the treatment received. The demographic parameters, for example, could include patient's age, gender, race, ethnicity, geographic location, et cetera, and disease characteristics would include the type and extent of the disease, pre-existing co-morbid conditions, number and type of prior treatment received for disease under investigation, pathological and/or molecular sub-type/ genetic variations of the disease under investigation etc. The outcomes data point could measure effectiveness or adverse events rates, for example, patient survival, progression or response, or adverse event/side effects for which the patient was admitted to the hospital or received treatment/transfusion etc. These parameters would describe the probability of survival, treatment effectiveness, adverse event rate, and demographics or disease characteristics prognosis and/or prediction.

### Description of FIG. 2

FIG. 2 illustrates various types of applications that can be derived from the clinical database, which serves as the platform for the depicted assessment options. The information in this clinical database can also be readily mined and analyzed for various types of epidemiological, clinical, safety, and other studies. Application of statistical tools can support the production of statistical reports that can allow the determination of therapeutic effectiveness and leads for new therapy options.

The diagram also depicts the subgroup isolation through a parameterized query process that allows statistical tools applications to support hypothesis generation, which would allow optimal determination of clinical sample size analysis and statistical probability assessment analyses in conjunction with clinical studies that could support interim or final safety analysis.

Consider the assessment of the sample size for a clinical trial, wherein one has to make assumptions based on existing therapy for a particular disease under consideration. The clinical database subgroup can be used to supply probability information to develop the number of patients required for a clinical study. The priori information available in the clinical database can augment and improve precision in the development and conduct of the clinical study design and calculation of sample size.

The clinical database can provide unidentified patient data to serve as historical and/or concurrent control in part or full for the clinical study. While the clinical trial is underway, the clinical database can also provide the requisite information to support both Prequentist and Bayesian approaches for assessing interim or final safety analysis.

1. A system of compiling a clinical database using extractions from healthcare database using specifically programmed variables that can present the patient demographics and the associated diseases characteristics, diagnostic, treatment, and outcomes data for unidentified patients.

2. Further to claim 1, permitting current statistical methods applied to clinical database for clinical study design and sample size calculation to test efficacy and safety.

3. Further to claim 1, determination of optimal study population characteristics to be recruited for future clinical trials to assess efficacy and safety.

4. Further to claim 1, identification and quantification of control therapies to be compared to new treatments alone or in combination with control therapies for efficacy and safety.

5. Further to claim 1, determination of statistical modeling and analysis methods to be initially tested using the clinical database to support a future clinical study.

6. Further to claim 1, identification, generation, and assessment of therapeutic endpoints using a clinical database to evaluate efficacy and safety in target populations.

7. Further to claim 1, identification, generation, and assessment of therapeutic endpoints using a clinical database to project efficacy and safety in new unserved populations.

8. Statistical methods applied to a priori data derived from pre-existing healthcare repositories to validate the outcomes from the interim analysis in clinical study thus influencing the decision to continue or to end a clinical study.

9. Further to claim 8, statistical methods to project clinical trial outcomes corresponding to the patients enrolled in randomized clinical trials as a measure of study validation.

10. Further to claim 8, statistical methods to project outcomes for different populations beyond approved indications for use.

11. Comparison of outcomes against other competing treatment outcomes derived from preexisting healthcare repositories for efficacy and safety.
